(19) United States
(12) Patent Application Publication
(10) Pub. No.: US 2013/0021306 A1
(43) Pub. Date: Jan. 24, 2013

(54) DISPLAY PANEL DRIVING APPARATUS AND OPERATION METHOD THEREOF AND SOURCE DRIVER THEREOF

(71) Applicants: Te-Hsien Kuo, Keelung City (TW); Hsiu-Hui Yang, Hsinchu City (TW); Chin-Hung Hsu, Taoyuan County (TW)

(72) Inventors: Te-Hsien Kuo, Keelung City (TW); Hsiu-Hui Yang, Hsinchu City (TW); Chin-Hung Hsu, Taoyuan County (TW)

(73) Assignee: NOVATEK MICROELECTRONICS CORP., Hsinchu (TW)

(21) Appl. No.: 13/286,225

(22) Filed: Nov. 1, 2011

(30) Foreign Application Priority Data
Jul. 20, 2011 (TW) 100125601

(51) Int. Cl. G09G 5/00

(52) U.S. Cl. 345/204

(57) ABSTRACT

A display panel driving apparatus and an operation method thereof and a source driver thereof are provided. The display panel driving apparatus includes a timing controller and a source driver. The timing controller outputs display data and error-check data. The source driver generates source driving signals for driving a display panel in accordance with the display data provided from the timing controller, and checks the display data in accordance with the error-check data provided from the timing controller.

### CROSS-REFERENCE TO RELATED APPLICATION

This application claims the priority benefit of Taiwan application serial no. 100125601, filed on Jul. 20, 2011. The entirety of the above-mentioned patent application is hereby incorporated by reference herein and made a part of this specification.

### BACKGROUND OF THE INVENTION

1. Field of the Invention

The invention relates to a display apparatus and more particularly to a display panel driving apparatus, an operation method thereof, and a source driver thereof.

2. Description of Related Art

In a conventional display panel driving apparatus, the data/control signal transmission between the timing controller and the source driver is a one-way transmission; that is, from the timing controller to the source driver. The timing controller frequently transmits a large amount of display data to the source driver. In the transmission of the display data from the timing controller to the source driver, various types of interference, for example, electromagnetic interference (EMI) can alter the display data. When receiving the erroneous display data, the source driver drives the display panel with the erroneous driving signal. However, the conventional source driver fails to determine whether the display data received from the timing controller are correct or not.

### SUMMARY OF THE INVENTION

The invention is directed to a display panel driving apparatus, an operation method thereof, and a source driver thereof. The source driver checks a display data provided from a timing controller to prevent writing an erroneous source driving signal into a display panel.

An embodiment is directed to a display panel driving apparatus including a timing controller and a source driver. The timing controller outputs a display data and an error-check data. The source driver is coupled to the timing controller. The source driver generates a source driving signal for driving a display panel in accordance with the display data and checks the display data in accordance with the error-check data.

An embodiment is directed to a method of operating a display panel driving circuit. The method includes: transmitting a display data and an error-check data from a timing controller to a source driver; generating a source driving signal used to drive a display panel with the source driver in accordance with the display data; and checking the display data with the source driver in accordance with the error-check data.

An embodiment is directed to a source driver including a plurality of channels and an error detector. The channels each generates a source driving signal used to drive a display panel in accordance with a display data output by a timing controller. The error detector checks the display data of the channels in accordance with an error-check data output by the timing controller.

In light of the foregoing, the source driver of the embodiment receives the display data and the error-check data from the timing controller. The source driver checks the display data in accordance with the error-check data to prevent writing the erroneous source driving signal in to the display panel.

In order to make the aforementioned and other features and advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate embodiments and, together with the description, serve to explain the principles of the invention.

FIG. 1 is a schematic functional block diagram illustrating a display panel driving apparatus according to an embodiment.

FIG. 2 is a schematic signal timing diagram of the display panel driving apparatus in FIG. 1 according to an embodiment.

FIG. 3 is a schematic functional block diagram illustrating a source driver in FIG. 1 according to an embodiment.

FIG. 4 is a schematic functional block diagram showing an error detector in FIG. 3 according to an embodiment.

FIG. 5 is a schematic functional block diagram showing an error detector in FIG. 3 according to another embodiment.

FIG. 6 is a schematic functional block diagram illustrating a source driver in FIG. 1 according to another embodiment.

FIG. 7 depicts a schematic circuit diagram of a control circuit in FIG. 6 according to another embodiment.

FIG. 8 is a schematic functional block diagram illustrating a display panel driving apparatus according to another embodiment.

FIG. 9 is a schematic signal timing diagram of the display panel driving apparatus in FIG. 8 according to an embodiment.

FIG. 10 is a schematic signal timing diagram of the display panel driving apparatus in FIG. 1 according to another embodiment.

### DESCRIPTION OF EMBODIMENTS

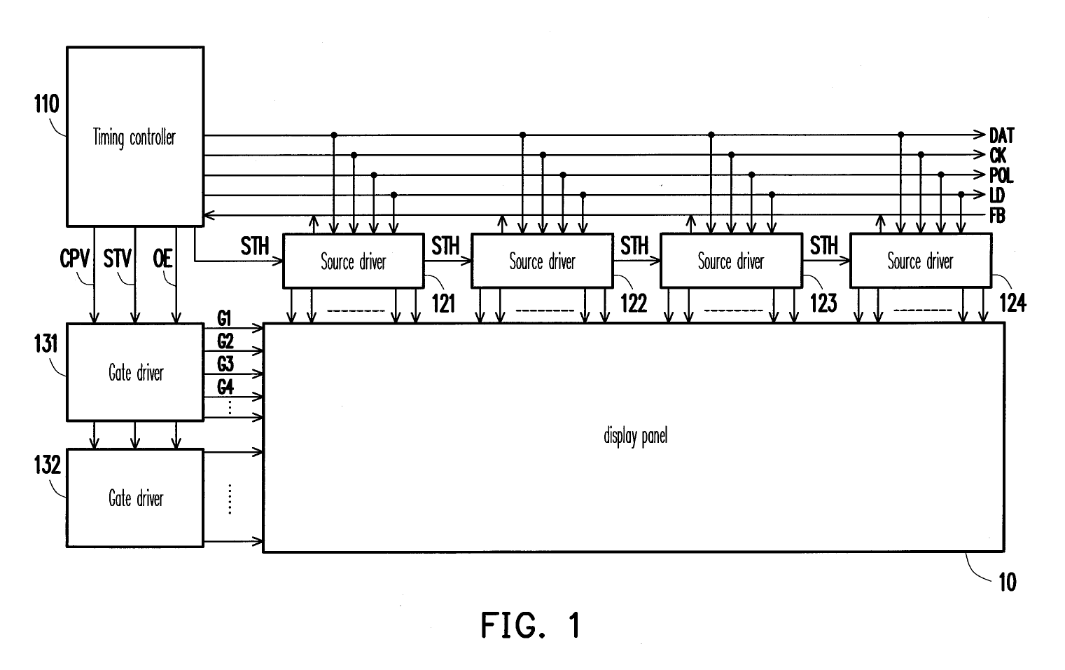

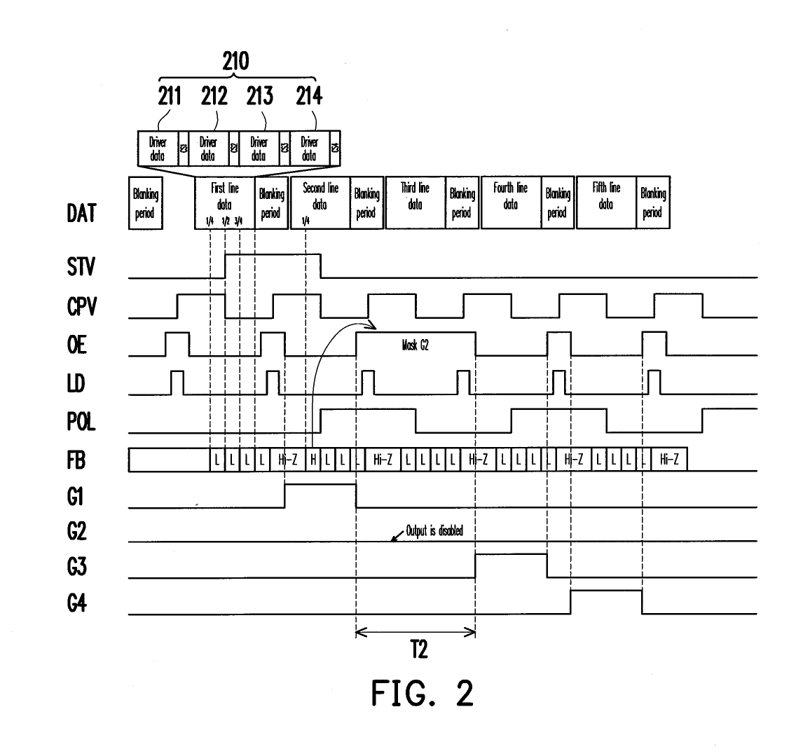

The invention can be applied in driving apparatuses of any types of displays. For example, FIG. 1 is a schematic functional block diagram illustrating a display panel driving apparatus according to an embodiment. The display panel driving apparatus includes a timing controller 110, at least one source driver (for example, source drivers 121, 122, 123, and 124), and at least one gate driver (for example, gate drivers 131 and 132). FIG. 2 is a schematic signal timing diagram of the display panel driving apparatus in FIG. 1 according to an embodiment. Here, various control signals are illustrated. However, different control signals and driving mechanisms can be adopted in other embodiments. Those with common knowledge in the art can adopt any types of display driving apparatuses according to their demands in design and apply the embodiments shown in FIG. 1 and FIG. 2 to their adopted types of display driving apparatuses according to the demonstration in the embodiments disclosed here.

Referring to FIGS. 1 and 2, the gate drivers 131 and 132 are coupled between the timing controller 110 and a display panel 10. After the gate drivers 131 and 132 receive a vertical start signal STV provided by the timing controller 110, the vertical start signal STV undergoes a successive transition in accordance with a timing of a gate clock signal CPV in the gate drivers 131 and 132. Therefore, the gate drivers 131 and 132 can drive each of a plurality of scan lines of the display panel 10 one by one in accordance with a transition position of the vertical start signal STV. For instance, a scan line G1 is driven first, and a plurality of scan lines G2, G3, G4, and so on are driven sequentially. The timing controller 110 provides an output enable signal OE (or an output disable signal) to the gate drivers 131 and 132 through a control bus so as to control an output of the gate drivers 131 and 132 to be in an enable state or a disable state. For instance, the timing controller 110 provides the output enable signal OE in the disable state (i.e. logic 0) to the gate drivers 131 and 132 through the control bus in a period T2 to mask the scan line G2. Therefore, a driving pulse of the scan line G2 in the period T2 is disabled/cancelled as shown in FIG. 2.

The source drivers 121-124 are coupled between the timing controller 110 and the display panel 10. After the source drivers 121-124 receive a horizontal start signal STH provided by the timing controller 110, the horizontal start signal STH undergoes a successive transition in accordance with a timing of a source clock signal CK in the source drivers 121-124. The timing controller 110 outputs a plurality of line data (display data) to a data line bus DAT sequentially in series. The source drivers 121-124 can thus obtain the display data from the data line bus DAT. In the present embodiment, the data line bus DAT is exemplified as a bus satisfying the specification of mini low voltage differential signaling (mini-LVDS), for purpose of illustration.

A horizontal blanking period and a reset period are present between two adjacent line data. Since the source drivers 121-124 are connected in parallel at the data line bus DAT, each of a plurality of line data transmission periods is divided into four sub-periods for transmitting the display data of one of the source drivers respectively. For instance, referring to FIG. 2, a line data transmission period 210 used to transmit the display data required by the first scan line G1 can be divided into four sub-periods 211, 212, 213, and 214. The sub-periods 211-214 are configured to transmit the display data of the source drivers 121-124 respectively. With the control of the source clock signal CK, the horizontal start signal STH, a latching signal LD, and a polarity control signal POL that are output by the timing controller 110, the source drivers 121-124 can convert the display data of the data line bus DAT into the source driving signal and write the source driving signal into a plurality of pixels in the display panel 10 following a scanning timing of the gate drivers 131-132 so as to display an image.

Other than the display data, the timing controller 110 in the present embodiment also transmits the error-check data in the display data to the source drivers 121-124 through the data line bus DAT. After the display data of a source driver are received, this source driver then continues to receive the corresponding error-check data. For example, referring to FIG. 2, the timing controller 110 transmits an error-check data CS1 of a first line data (display data) of the source driver 121 after the sub-period 211. The timing controller 110 transmits an error-check data CS2 of a first line data of the source driver 122 after the sub-period 212. The timing controller 110 transmits an error-check data CS3 of a first line data of the source driver 123 after the sub-period 213. The timing controller 110 further transmits an error-check data CS4 of a first line data of the source driver 124 after the sub-period 214.

The error-check data can be a complement of the display data, a complement of a total sum of the display data, a total sum of the display data, or other error checking and correction (ECC) codes. For instance, the sub-period 211 corresponds to the first line data (display data) of the source driver 121, such that the error-check data CS1 are 2's complement of a total sum of the first line data of the source driver 121. The source driver 121 checks whether a sum value of a total sum of the error-check data CS1 and the display data equals to 0 to determine whether the display data are erroneous. Or, for example, the error-check data CS1 are a total sum of the first line data of the source driver 121. The source driver 121 cumulates the display data (the first line data) to obtain a cumulative value and compares the cumulative value and the error-check data CS1 to determine whether the display data (the first line data) are erroneous.

The source drivers 121-124 check the corresponding display data in accordance with the error-check data (i.e. the error-check data CS1-CS4) respectively. When any one of the source drivers 121-124 detects an error in the display data, the source driver feeds an error message back to the timing controller 110 through a feedback bus FB. When any one of the source drivers 121-124 feeds the error message back to the timing controller 110, the timing controller 110 transmits the output enable signal OE in the disable state (i.e. logic 0) to a gate drivers 131 and 132 through the control bus, so that the gate drivers 131 and 132 do not drive one of (or several of) a plurality of corresponding gate lines in the display panel 10.

For instance, referring to FIG. 2, when detecting an error in the second line data (that is, the display data required by the second scan line G2), the source driver 121 feeds an error message (i.e. logic high “H”) back to the timing controller 110 through the feedback bus FB. In accordance with the error message of the feedback bus FB, the timing controller 110 transmits the output enable signal OE in the disable state (i.e. logic 0) to the gate drivers 131 and 132 through the control bus in the period T2 to mask a driving pulse of the second scan line G2. That is, the gate drivers 131 and 132 are prevented from driving the second scan line G2 in the display panel 10.

In other words, when the gate drivers 131 and 132 receive the output enable signal OE in the disable state (i.e. logic 0) through the control bus, the gate drivers 131 and 132 do not turn on the pixels on the aforementioned corresponding gate lines. Therefore, when any one of the source drivers 121-124 detects an error in the display data, the erroneous display data are not written into the pixels of the display panel 10. The source drivers 121-124 have the ability of detecting errors. The display panel driving apparatus shown in FIG. 1 can thus prevent the display panel 10 from displaying obvious erroneous frames or prevent the interference of noise.

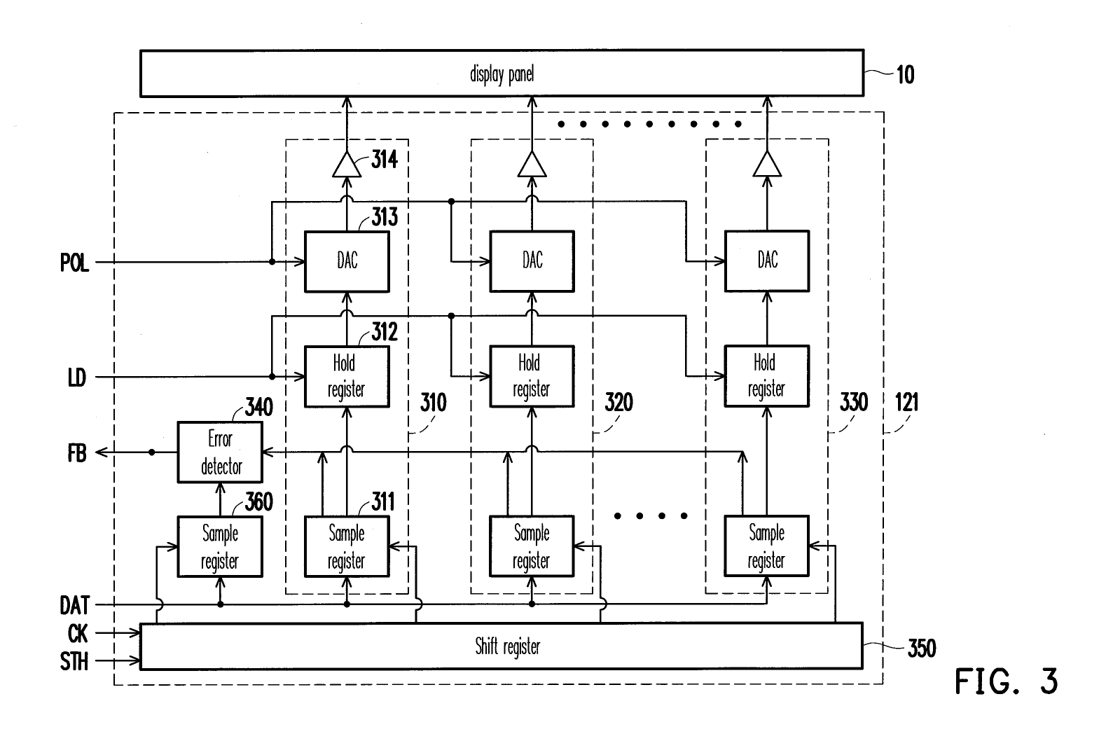

FIG. 3 is a schematic functional block diagram illustrating the source driver 121 in FIG. 1 according to an embodiment. The implementation of other source drivers 122-124 in FIG. 1 can be referred to relevant descriptions of the source driver 121. The source driver 121 includes a plurality of channels (for example, channels 310, 320, and 330), an error detector 340, and a shift register 350. After the shift register 350 receives the horizontal start signal STH provided by the timing controller 110, the horizontal start signal STH undergoes a successive transition in accordance with the timing of the source clock signal CK in the shift register 350. Accordingly, the shift register 350 triggers the channels 310-330 one by one to latch the display data output by the timing controller 110. After the channels 310-330 complete a reception of the display data, a sample register 360 of the source driver 121 receives and latches the error-check data of the display data (i.e. the error-check data CS1 shown in FIG. 2). After the source driver 121 completes the reception of the error-check data, the error detector 340 checks the display data of the channels 310-330 in accordance with the error-check data output from the timing controller 110 (provided by the sample register 360) and feeds a checking result back to the timing controller 110 through the feedback bus FB. When the display data of at least one channel among the channels 310-330 are erroneous, the error detector 340 feeds an error message back to the timing controller 110 through the feedback bus FB.

On the other hand, each of the channels 310-330 generates a source driving signal used to drive the display panel 10 in accordance with the display data output by the timing controller 110. In the present embodiment, each of the channels 310-330 of the source driver 121 includes a sample register, a hold register, a digital-to-analog converter (DAC), and an output buffer. Take the channel 310 as an example, the channel 310 includes a sample register 311, a hold register 312, a digital-to-analog converter 313, and an output buffer 314. The implementation of other channels 320-330 can be referred to relevant descriptions of the channel 310. According to a trigger timing of the shift register 350, the sample register 311 records the display data output by the timing controller 110 through the data line bus DAT and the sample register 360 records the error-check data output by the timing controller 110 through the data line bus DAT. The hold register 312 responds to the latching signal LD of the timing controller 110 to determine whether or not to latch the display data output by the sample register 311. The digital-to-analog converter 313 converts a digital display data output by the hold register 312 into an analog source driving signal. Here, the polarity control signal POL determines whether the source driving signal output by the digital-to-analog converter 313 has positive polarity or negative polarity. The source driving signal output by the digital-to-analog converter 313 can be transmitted to the display panel 10 through the output buffer 314.

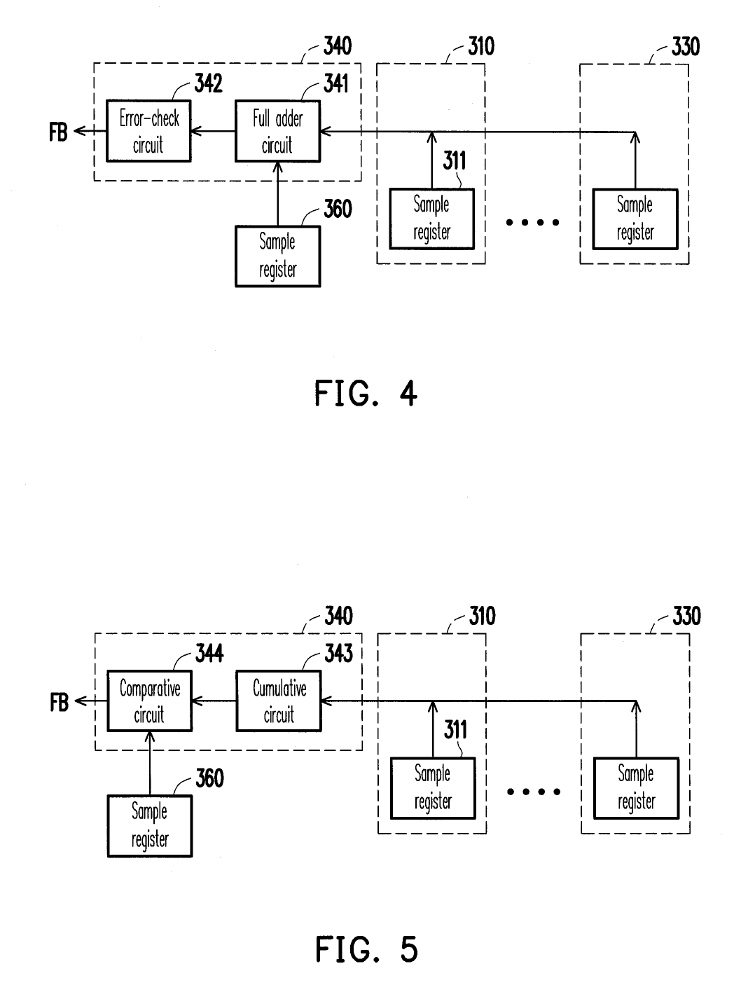

FIG. 4 is a schematic functional block diagram showing an error detector 340 in FIG. 3 according to an embodiment. In the present embodiment, the error-check data output by the timing controller 110 (provided by the sample register 360) are a complement of a total sum of the display data of the channels 310-330 (provided by the sample register of each of the channels). The error detector 340 includes a full adder circuit 341 and an error-check circuit 342. While the display data are read by the sample registers of the channels 310-330, the display data of each of the channels are summed by the full adder circuit 341 to obtain a channel data sum value. After the display data of all of the channels 310-330 have been summed, the error-check data provided by the sample register 360 and the channel data sum value aforementioned are added by the full adder circuit 341, where an addition result is output to the error-check circuit 342. The error-check circuit 342 receives and checks the output of the full adder circuit 341 and identifies a checking result as an error message so as to notify the timing controller 110 through the feedback bus FB.

For example, in the present embodiment, the error-check data provided by the sample register 360 can be 2's complement. Therefore, if the display data of the channels 310-330 are correct, then all output bits (not including carry bits) of the full adder circuit 341 are “0”. Consequently, the error-check circuit 342 can check whether the output bits of the full adder circuit 341 are all “0”. The error-check circuit 342 can be an OR gate, where each of a plurality of input ends of the OR gate receives one of the output bits of the full adder circuit 341 respectively, and an output end of the OR gate connects to the feedback bus FB. When all of the output bits of the full adder circuit 341 are “0”, the display data received by the channels 310-330 are then correct, and the error-check circuit 342 does not raise the feedback bus FB to high logic “H”. When any one of the bits in all of the output bits in the full adder circuit 341 is “1”, then the display data received by the channels 310-330 are abnormal. When the display data received by the channels 310-330 are erroneous, the error-check circuit 342 raises the feedback bus FB to high logic “H”, so that the timing controller 110 can disable the output of the gate drivers 131 and 132 to prevent the driving of the corresponding scan lines in the display panel 10. Thus, even though the source driver 121 outputs the erroneous display data, since the corresponding scan line is not driven and the pixels are not turned on, the erroneous display data are not displayed on the display panel 10. Accordingly, all of the pixels in the corresponding scan lines maintain the display data of the last frame.

For example, in other embodiments, the error-check data provided by the sample register 360 can be 1's complement. Therefore, if the display data of the channels 310-330 are correct, then the output bits (not including carry bits) of the full adder circuit 341 are all “1”. The error-check circuit 342 can be an NAND gate, where each of a plurality of input ends of the NAND gate receives one of the output bits of the full adder circuit 341 respectively, and an output end of the NAND gate connects to the feedback bus FB. Accordingly, the error-check circuit 342 can determine whether the display data received by the channels 310-330 is incorrect in accordance with the output of the full adder circuit 341. The error-check circuit 342 can then feed the error message back to the timing controller 110 through the feedback bus FB.

FIG. 5 is a schematic functional block diagram showing the error detector 340 in FIG. 3 according to another embodiment. In the present embodiment, the error-check data output by the timing controller 110 (provided by the sample register 360) are a complement of a total sum of the display data of the channels 310-330 (provided by the sample register of each of the channels). The error detector 340 includes a cumulative circuit 343 and a comparative circuit 344. While the display data are read by the sample registers of the channels 310-330, the display data of each of the channels are summed by the cumulative circuit 343 to obtain a cumulative value. After the display data of all of the channels 310-330 are added, the cumulative circuit 343 outputs the cumulative value to the comparative circuit 344. The comparative circuit 344 compares the cumulative value provided by the cumulative circuit 343 and the error-check data provided by the sample register 360, and identifies a comparing result as an error message to notify the timing controller 110 through the feedback bus FB. Here, if the cumulative value output by the cumulative circuit 343 is identical to the error-check data provided by the sample register 360, the display data received by the channels 310-330 are then correct. Therefore, the comparative circuit 344 does not raise the feedback bus FB to high logic “H”. If the cumulative value output by the cumulative circuit 343 is different from the error-check data provided by the sample register 360, the display data received by the channels 310-330 are abnormal. The comparative circuit 344 then raises the feedback bus FB to high logic “H”.

Referring to FIG. 1 simultaneously, after outputting sequentially, each of the source drivers 121-124 outputs the horizontal start signal STH to the next source driver. Since each of the source drivers 121-124 receives the display data and the error-check data at different times respectively, the error detector 340 of the source drivers 121-124 lowers a level of the feedback bus FB to low logic “L” or raises the level to high logic “H” at different times. At other times, the level of the feedback bus FB is in a high-resistance Hi-Z state as shown in FIG. 2. Thus, unnecessary power consumption on the feedback bus FB and the interference of the feedback bus FB signals between the source drivers 121-124 can be prevented. In terms of the timing controller 110, a connection terminal coupled to the feedback bus FB can be connected to a pull-low resistance, and a default signal of the feedback bus FB is thus low logic “L” (or logic “0”). Whenever the feedback bus FB is raised to high logic “H” by any one of the source drivers 121-124, the signal received by the source driver is erroneous.

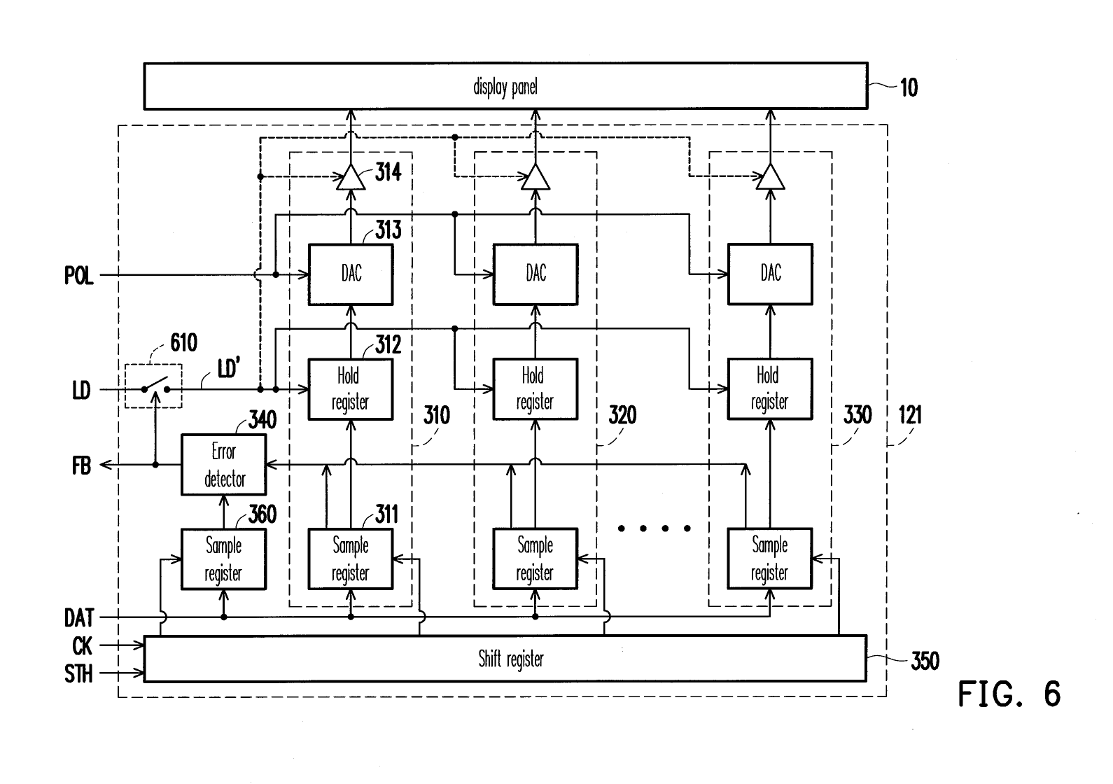

FIG. 6 is a schematic functional block diagram illustrating the source driver 121 in FIG. 1 according to another embodiment. The implementation of other source drivers 122-124 in FIG. 1 can be referred to relevant descriptions of the source driver 121. The source driver 121 depicted in FIG. 6 can refer to relevant descriptions of the embodiment shown in FIG. 3. Different from the embodiment illustrated in FIG. 3, the source driver 121 in FIG. 6 further includes a control circuit 610. The control circuit 610 generates a control signal LD′ in accordance with the error message of the feedback bus FB and the latching signal LD output by the timing controller 110. The hold registers of the channels 310-330 (for example, the hold register 312) respond to the control signal LD′ and determine whether or not to latch the display data output by the sample registers of the channels 310-330 (for example, the sample register 311).

When the error detector 340 of the source driver 121 determines the display data of the channels 310-330 to be correct, the control circuit 610 transmits the latching signal LD to the hold registers of the channels 310-330 (for example, the hold register 312) as the control signal LD′. When the error detector 340 of the source driver 121 detects an error in the display data of the channels 310-330, the control circuit 610 stops the output of the control signal LD′ in accordance with the error message of the feedback bus FB. Since the latching signal LD is masked and fails to trigger the hold registers of the channels 310-330, the erroneous display data is not written into the hold registers, such that the hold registers maintain the display data of the last scan line. Accordingly, the source driver 121 depicted in FIG. 6 prevents the writing of the erroneous display data into the display panel 10. Moreover, when an error is detected in the display data of the channels 310-330, since the hold registers maintain the display data of the last scan line, the channels 310-330 do not need to undergo signal transition and can save on power consumption.

In other embodiments, the control circuit 610 further connects to a plurality of output buffers of the channels 310-330 (for example, the output buffer 314). When the error detector 340 identifies the display data of the channels 310-330 to be correct, the control circuit 610 transmits the control signal LD′ and enables the output buffers of the channels 310-330. When the error detector 340 detects an error in the display data of the channels 310-330, the control circuit 610 stops the output of the control signal LD′ in accordance with the error message of the feedback bus FB. The latching signal LD is masked, such that the output buffers of the channels 310-330 are disabled. In other words, when the display data of the channels 310-330 are erroneous, the source driver 121 stops outputting the source driving signal to the display panel 10 so as to prevent the writing of erroneous source driving signal (display data) into the display panel 10. Further, when the display data of the channels 310-330 are erroneous, the power consumption can be reduced since the output buffers of the channels 310-330 are disabled.

The control circuit 610 can be a controlled switch. A control terminal of the controlled switch is connected to the error detector 340 through the feedback bus FB. A first terminal of the controlled switch is connected to the timing switch 110 to receive the latching signal LD. A second terminal of the controlled switch is connected to the hold registers of the channels 310-330 to provide the control signal LD′.

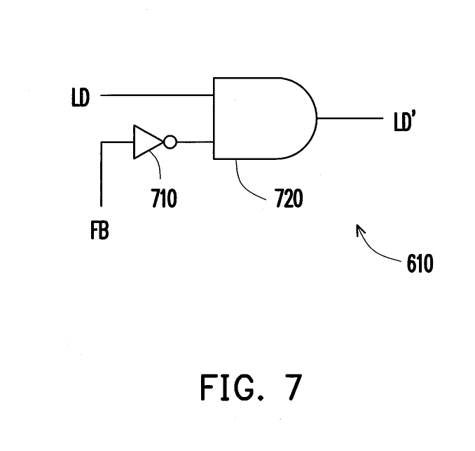

FIG. 7 depicts a schematic circuit diagram of the control circuit 610 in FIG. 6 according to another embodiment. In the present embodiment, the control circuit 610 includes a NOT gate 710 and an AND gate 720. An input terminal of the NOT gate is connected to the error detector 340 through the feedback bus FB. A first input terminal of the AND gate 720 is connected to an output terminal of the NOT gate 710. A second input terminal of the AND gate 720 is connected to the timing controller 110 to receive the latching signal LD. An output terminal of the AND gate 720 is connected to the hold registers of the channels 310-330 to provide the control signal LD′.

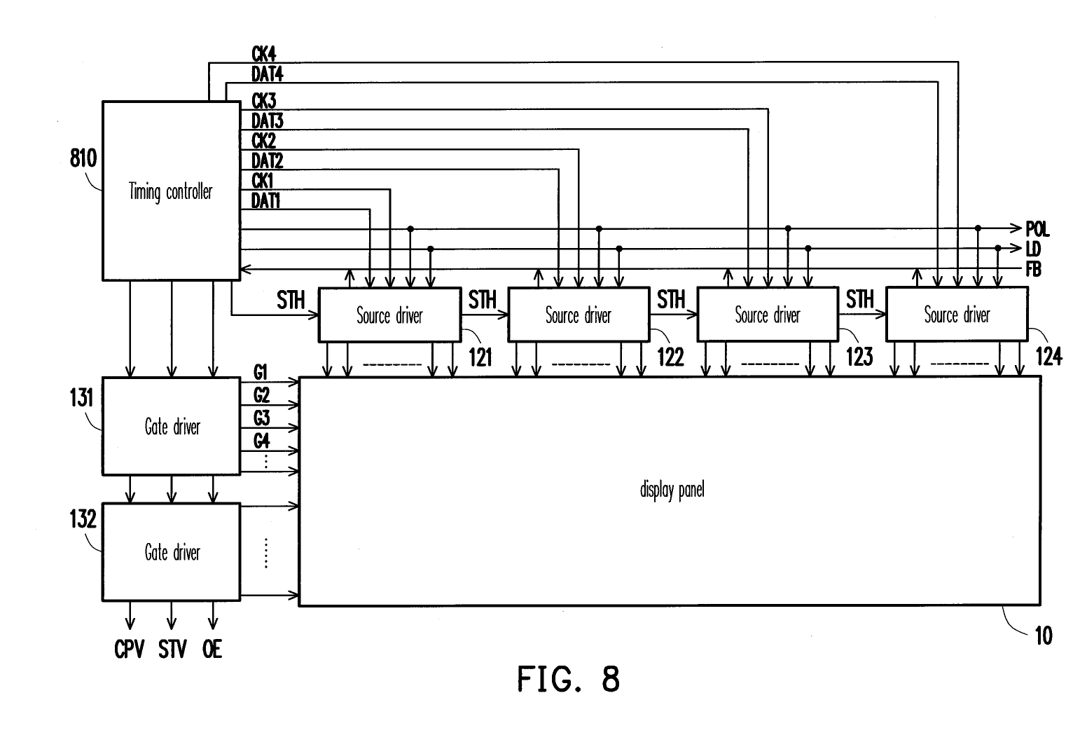

FIG. 8 is a schematic functional block diagram illustrating a display panel driving apparatus according to another embodiment. The display panel driving apparatus shown in FIG. 8 can refer to relevant descriptions of the embodiments depicted in FIGS. 1, 3, and 6. Different from the embodiment shown in FIG. 1, a data transmission interface between a timing controller 810 and the source drivers 121-124 illustrated in FIG. 8 adopts a peer-to-peer (P2P) transmission technique. For example, the timing controller 810 outputs a source clock signal CK1 and a display data DAT1 to the source driver 121, outputs a source clock signal CK2 and a display data DAT2 to the source driver 122, outputs a source clock signal CK3 and a display data DAT3 to the source driver 123, and outputs a source clock signal CK4 and a display data DAT4 to the source driver 124.

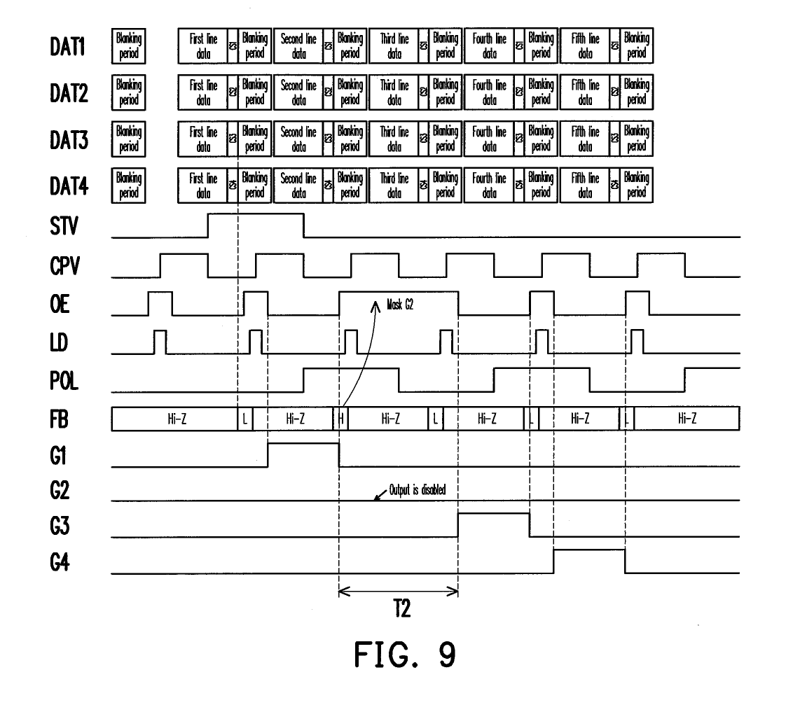

FIG. 9 is a schematic signal timing diagram of the display panel driving apparatus in FIG. 8 according to an embodiment. Referring to FIGS. 1 and 2, in the display data DAT1, there exist a blanking period and a reset period between the display data of two adjacent scan lines. Moreover, the display data of each of the scan lines is followed by a corresponding error-check data CS1. The display data DAT2, DAT3, and DAT4 have similar data structures. With the control of the source clock signals CK1-CK4, the horizontal start signal STH, the latching signal LD, and the polarity control signal POL that are output by the timing controller 810, the source drivers 121-124 can convert the display data in the display data DAT1-DAT4 into the source driving signal and write the source driving signal into a plurality of pixels in the display panel 10 in accordance with a scanning timing of the gate drivers 131-132 so as to display an image.

Other than the display data, the source drivers 121-124 in the present embodiment can receive the error-check data CS1, CS2, CS3, and CS4 from the display data DAT1-DAT4 respectively. The source drivers 121-124 check the corresponding display data in accordance with the error-check data CS1-CS4 respectively. When any one of the source drivers 121-124 detects an error in any one of the display data DAT1-DAT4, the source driver feeds an error message back to the timing controller 810 through a feedback bus FB. When any one of the source drivers 121-124 feeds the error message back to the timing controller 810, the timing controller 810 can send the output enable signal OE in the disable state (i.e. logic 0) to a gate drivers 131 and 132 through the control bus, so that the gate drivers 131 and 132 do not drive one (or several) of a plurality of corresponding gate lines in the display panel 10.

For instance, referring to FIG. 9, when detecting an error in the second line data (that is, the display data required by the second scan line G2) in any one of the display data DAT1-DAT4, the source driver feeds an error message (i.e. high logic “H”) back to the timing controller 810 through the feedback bus FB. In accordance with the error message of the feedback bus FB, the timing controller 810 transmits the output enable signal OE in the disable state (i.e. logic 0) to the gate drivers 131 and 132 through the control bus in the period T2 to mask a driving pulse of the second scan line G2. That is, the gate drivers 131 and 132 are prevented from driving the second scan line G2 in the display panel 10.

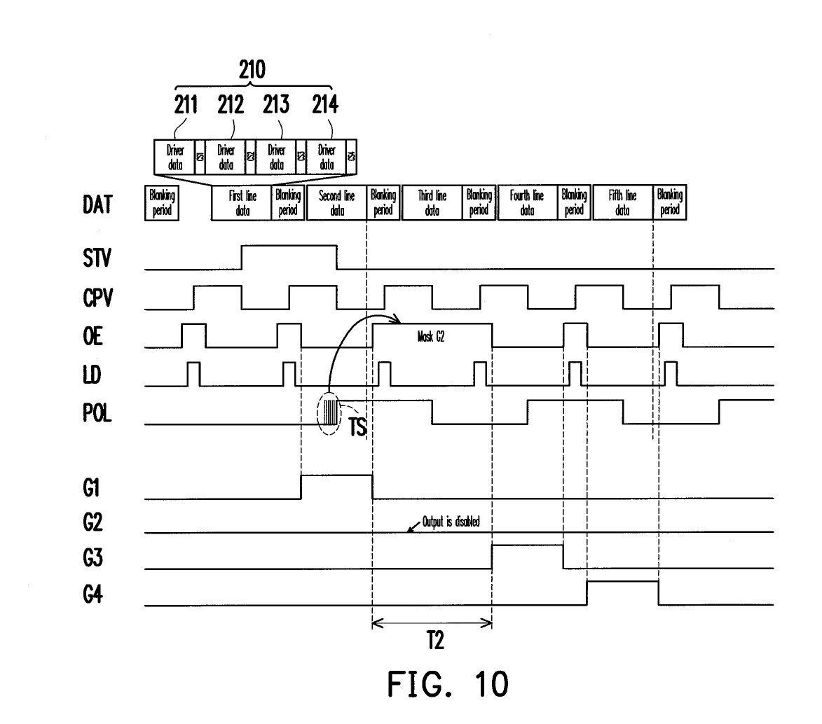

In the embodiments aforementioned, the source drivers 121-124 adopt the feedback bus FB as the transmission interface when feeding the error message to the timing controller 110 (or 810). In other embodiments, the feedback bus FB can be omitted and the error message can be fed back to the timing controller 110 through other conventional buses. For example, referring to FIG. 1, the error message can be embedded in a bus for a polarity control signal POL so as to omit the feedback bus FB. FIG. 10 is a schematic signal timing diagram of the display panel driving apparatus in FIG. 1 according to another embodiment. Referring to FIG. 10, the source drivers 121-124 in the present embodiment feed the error message back to the timing controller 110 through the bus for the polarity control signal POL. The source drivers 121-124 check the corresponding display data in accordance with the error-check data (i.e. the error-check data CS1-CS4) respectively.

For instance, referring to FIG. 10, when detecting an error in the second line data (that is, the display data required by the second scan line G2), the source driver 121 transmits a toggling signal (i.e. a toggling signal TS shown in FIG. 10) to the timing controller 110 through the bus for the polarity control signal POL. In other words, when the source driver 121 detects an error in the display data, the source driver 121 can repeatedly raise and lower the level of the bus in a pre-determined period of time to indicate an error message. The timing controller 110 can monitor the bus for the polarity control signal POL. When the timing controller 110 identifies the toggling signal (that is, the error message) in the bus, the timing controller 110 then transmits the output enable signal OE in the disable state (i.e. logic 0) to the gate drivers 131 and 132 through the control bus in the period T2 to mask a driving pulse of the second scan line G2. That is, the gate drivers 131 and 132 are prevented from driving the second scan line G2 in the display panel 10.

In summary, a method of operating a display panel driving circuit is illustrated herein. The method includes: sending the display data and the error-check data from the timing controller to the source drivers 121-124; generating a source driving signal used to drive the display panel 10 with the source drivers 121-124 in accordance with the display data; and checking the display data with the source drivers 121-124 in accordance with the error-check data.

In some of the embodiments, the timing controller 110 transmits the corresponding error-check data to the source driver after the complete transmission of the display data of all of the channels in one of the source drivers. After completing the reception of the error-check data, the source driver checks the display data of the channels in accordance with the error-check data and feeds the checking result back to the timing controller 110. It should be noted that in other embodiments, the timing controller 110 can transmit the error-check data to one of the source drivers and transmit the corresponding display data to all of the channels in the source driver.

In some of the embodiments, when an error is detected in the display data, one of the source drivers 121-124 feeds the error message back to the timing controller 110. When the source drivers 121-124 feed the error message back to the timing controller 110, an output enable signal is transmitted from the timing controller 110 to the gate drivers 131 and 132. When the gate driver 131 and 132 receive the output enable signal in the disable state (i.e. logic 0), the gate drivers 131 and 132 do not drive a corresponding gate line in the display panel 10. In other embodiments, when detecting an error in the display data, the source drivers 121-124 stop outputting the source driving signal to the display panel 10.

In some of the embodiments, the step of checking the display data includes: summing the error-check data and the display data to obtain a sum value; and checking whether the sum value equals to 0 to determine whether the display data is erroneous. In some of the embodiments, the step of checking the display data includes: cumulating the display data to obtain a cumulative value; and comparing the cumulative value and the error-check data to determine whether the display data is erroneous.

The source drivers 121-124 in the embodiments receive the display data and the error-check data from the timing controller 110. The source drivers 121-124 check the display data in accordance with the error-check data to prevent writing the erroneous source driving signal into the display panel 10.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A display panel driving apparatus, comprising:
a timing controller configured to output a display data and an error-check data; and
a source driver, coupled to the timing controller to generate a source driving signal for driving a display panel in accordance with the display data and check the display data in accordance with the error-check data.

2. The display panel driving apparatus as claimed in claim 1, wherein the source driver feeds an error message back to the timing controller when detecting an error in the display data.

3. The display panel driving apparatus as claimed in claim 2, further comprising:
a gate driver, coupled to the timing controller,
wherein when the source driver feeds the error message back to the timing controller, the timing controller transmits an output enable signal in a disable state to the gate driver, such that the gate driver does not drive a corresponding gate line in the display panel.

4. The display panel driving apparatus as claimed in claim 1, wherein the source driver stops outputting the source driving signal when detecting an error in the display data.

5. The display panel driving apparatus as claimed in claim 1, wherein the source driver comprises a plurality of channels, and the source driver receives the error-check data of the display data after the channels complete a reception of the display data.

6. The display panel driving apparatus as claimed in claim 5, wherein after completing the reception of the error-check data, the source driver checks the display data of the channels in accordance with the error-check data and feeds a checking result back to the timing controller.

7. The display panel driving apparatus as claimed in claim 1, wherein the error-check data is a complement of the display data or a complement of a total sum of the display data.

8. The display panel driving apparatus as claimed in claim 1, wherein the source driver checks whether a sum value of a total sum of the error-check data and the display data equals to zero to determine whether the display data is erroneous.

9. The display panel driving apparatus as claimed in claim 1, wherein the source driver cumulates the display data to obtain a cumulative value and compares the cumulative value and the error-check data to determine whether the display data is erroneous.

10. The display panel driving apparatus as claimed in claim 1, wherein the source driver comprises:
an error detector, checking the display data in accordance with the error-check data, wherein when the display data is erroneous, the error detector feeds back an error message to the timing controller.

11. The display panel driving apparatus as claimed in claim 10, wherein the error-check data is a complement of a total sum of the display data, the error detector comprising:
a full adder circuit, adding the error-check data and the display data; and
an error-check circuit, receiving and checking an output of the full adder circuit and identifying a checking result as the error message to notify the timing controller.

12. The display panel driving apparatus as claimed in claim 10, wherein the error detector comprises:
a cumulative circuit, cumulating the display data to output a cumulative value; and
a comparative circuit, comparing the cumulative value and the error-check data and identifying a comparing result as the error message to notify the timing controller.

13. The display panel driving apparatus as claimed in claim 10, wherein the source driver further comprises:
a sample register, recording the display data and the error-check data output by the timing controller;
a control circuit, generating a control signal in accordance with the error message and a latching signal output by the timing controller; and
a hold register, responding the control signal and determining whether or not to latch the display data output by the sample register.

14. A method of operating a display panel driving circuit, the method comprising:
transmitting a display data and an error-check data from a timing controller to a source driver;
generating a source driving signal used to drive a display panel with the source driver in accordance with the display data; and
checking the display data with the source driver in accordance with the error-check data.

15. The method of operating the display panel driving circuit as claimed in claim 14, further comprising:
when an error is detected in the display data, the source driver feeding an error message back to the timing controller.

16. The method of operating the display panel driving circuit as claimed in claim 15, further comprising:
when the source driver feeds the error message back to the timing controller, the timing controller transmitting an output enable signal in a disable state to a gate driver; and
when the gate driver receives the output enable signal in the disable state, the gate driver not driving a corresponding gate line in the display panel.

17. The method of operating the display panel driving circuit as claimed in claim 14, further comprising:
when the source driver detects an error in the display data, stop outputting the source driving signal.

18. The method of operating the display panel driving circuit as claimed in claim 14, wherein the source driver comprises a plurality of channels, and the source driver receives the error-check data of the display data after the channels complete a reception of the display data.

19. The method of operating the display panel driving circuit as claimed in claim 18, wherein after completing the reception of the error-check data, the source driver checks the display data of the channels in accordance with the error-check data and feeds a checking result back to the timing controller.

20. The display panel driving circuit as claimed in claim 14, wherein the error-check data is a complement of the display data or a complement of a total sum of the display data.

21. The method of operating the display panel driving circuit as claimed in claim 14, wherein the step of checking the display data comprises:
summing the error-check data and the display data to obtain a sum value; and
checking whether the sum value equals to 0 to determine whether the display data is erroneous.

22. The method of operating the display panel driving circuit as claimed in claim 14, wherein the step of checking the display data comprises:
cumulating the display data to obtain a cumulative value; and
comparing the cumulative value and the error-check data to determine whether the display data is erroneous.

23. A source driver, comprising:
a plurality of channels, each generating a source driving signal used to drive a display panel in accordance with a display data output by a timing controller; and
an error detector, checking the display data of the channels in accordance with an error-check data output by the timing controller.

24. The source driver as claimed in claim 23, wherein when detecting an error in the display data, the error detector feeds an error message back to the timing controller.

25. The source driver as claimed in claim 23, wherein when detecting an error in the display data, the source driver stops outputting the source driving signal.

26. The source driver as claimed in claim 23, wherein the source driver receives the error-check data of the display data after the channels complete a reception of the display data.

27. The source driver as claimed in claim 26, wherein after the source driver completes the reception of the error-check data, the error detector checks the display data of the channels in accordance with the error-check data and feeds a checking result back to the timing controller.

28. The source driver as claimed in claim 23, wherein the error-check data is a complement of the display data of the channels or a complement of a total sum of the display data of the channels.

29. The source driver as claimed in claim 23, wherein the error detector checks whether a sum value of a total sum of the error-check data and the display data equals to 0 to determine whether the display data is erroneous.

30. The source driver as claimed in claim 23, wherein the error detector cumulates the display data of the channels to obtain a cumulative value and comparing the cumulative value and the error-check data to determine whether the display data is erroneous.

31. The source driver as claimed in claim 23, wherein the error-check data is a complement of the display data, the error detector comprising:
a full adder circuit, adding the error-check data and the display data of the channels; and
an error-check circuit, receiving and checking an output of the full adder circuit and identifying a checking result as an error message to notify the timing controller.

32. The source driver as claimed in claim 23, wherein the error detector comprises:
a cumulative circuit, cumulating the display data to output a cumulative value; and
a comparative circuit, comparing the cumulative value and the error-check data and identifying a comparing result as the error message to notify the timing controller.

33. The source driver as claimed in claim 23, wherein each of the channels comprises a sample register and a hold register respectively, the sample registers record the display data and the error-check data output by the timing controller, and the source driver further comprises:
a control circuit, generating a control signal in accordance with an error message output by the error detector and a latching signal output by the timing controller,
wherein the hold registers respond the control signal and determines whether or not to latch the display data output by the sample registers.
